(19) United States
(12) Patent Application Publication
(10) Pub. No.: US 2005/0231623 A1
(43) Pub. Date: Oct. 20, 2005

(54) Imaging apparatus

(75) Inventor: Nobuo Suzuki, Kurokawa-gun (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/092,572

(22) Filed: Mar. 29, 2005

(30) Foreign Application Priority Data
Mar. 30, 2004 (JP) P.2004-097829

(51) Int. Cl. H04N 5/335

(52) U.S. Cl. 348/311; 348/294

(57) ABSTRACT

An imaging apparatus includes a photoelectric converting film stack type solid-state imaging device which has: a semiconductor substrate in which signal charge accumulating regions disposed to respectively correspond to pixels, and vertical and horizontal transfer paths of a charge-coupled device type that read out and transfer signal charges accumulated in the signal charge accumulating regions are formed; and a photoelectric converting film stacked on the semiconductor substrate, signal charges which are photoelectrically converted by the photoelectric converting film, and which correspond to an amount of incident light being to be accumulated in the signal charge accumulating regions, wherein the apparatus further comprises means for adding together signal charges of plural pixels in a process in which the signal charges which are read out from the signal charge accumulating regions to the vertical transfer paths are transferred to the horizontal transfer path through the vertical transfer paths and transferred at the horizontal transfer path to be output to an outside.

This application is based on Japanese Patent application JP 2004-097829, filed Mar. 30, 2004, the entire content of which is hereby incorporated by reference. This claim for priority benefit is being filed concurrently with the filing of this application.

### BACKGROUND OF THE INVENTION

1. Technical Field of the Invention

The present invention relates to an imaging apparatus comprising a photoelectric converting film stack type solid-state imaging device in which a photoelectric converting film that generates charges corresponding to the amount of received light is stacked on a semiconductor substrate, and more particularly to an imaging apparatus comprising a photoelectric converting film stack type solid-state imaging device in which signal charges generated in photoelectric converting film are transferred to be read out to the outside, through charge transfer paths formed on a semiconductor substrate.

2. Description of the Related Art

In a CCD solid-state imaging device or a CMOS solid-state imaging device which is mounted on a digital camera, a large number of photoelectric converting elements (photodiodes) serving as light receiving portions, and signal read circuits which read out photoelectric conversion signals obtained in the photoelectric converting elements are formed on the surface of a semiconductor substrate. The signal read circuits are configured by, in the case of a CCD device, charge transfer circuits and transfer electrodes, and, in the case of a CMOS device, MOS circuits and signal lines.

In a related art solid-state imaging device, therefore, many light receiving portions and signal read circuits must be formed on the same surface of a semiconductor substrate, thereby producing a problem in that the area for the light receiving portions cannot be increased.

A related art single-type solid-state imaging device has a configuration in which one of color filters of, for example, red (R), green (G), and blue (B) is stacked on each of light receiving portions, so that the light receiving portion detects a light signal of the one color. In the position of a light receiving portion which detects light of, for example, red, therefore, blue and green signals are obtained by interpolating detection signals of surrounding light receiving portions which detect blue light and green light, respectively. This causes a false color, and reduces the resolution. Furthermore, blue light and green light incident on a light receiving portion where a red color filter is formed does not contribute to photoelectric conversion, but is absorbed as heat into the color filter, thereby producing another problem in that the light use efficiency is poor and the sensitivity is low.

As described above, a related art solid-state imaging device has various problems. On the other hand, in such a device, the number of pixels is advancing. At present, a large number or several millions of pixels or light receiving portions are integrated on one semiconductor substrate, and the size of an opening of each of the light receiving portions is near the order of the wavelength. Consequently, a CCD device and a CMOS device are hardly expected to configure an image sensor which can solve the above-discussed problems, and which is superior in image quality and sensitivity than a related art one.

Therefore, attention is again paid to the structure of a solid-state imaging device which is disclosed in, for example, JP-A-58-103165 below. The solid-state imaging device has a structure where a red-detection photosensitive layer, a green-detection photosensitive layer, and a blue-detection photosensitive layer are stacked by a film growth technique on a semiconductor substrate in which signal read circuits are formed on the surface, these photosensitive layers are used as light receiving portions, and photoelectric conversion signals obtained in the photosensitive layers are supplied to the outside by the signal read circuits. Namely, the solid-state imaging device has a structure of a photoelectric converting film stack type.

In this structure, it is not required to dispose the light receiving portions on the surface of the semiconductor substrate. Therefore, restrictions on the design of the signal read circuits are largely eliminated, and the use efficiency of incident light is improved, so that the sensitivity is enhanced. Moreover, one pixel can detect light of the three primary colors red, green, and blue. Therefore, the resolution is improved, and a false color does not occur. As a result, it is possible to solve the above-discussed problems of a related art CCD or CMOS solid-state imaging device.

Consequently, solid-state imaging devices of the photoelectric converting film stack type disclosed in JP-A-2002-83946, JP-T-2002-502120, JP-T-2003-502847, and Japanese Patent No. 3405099 below have been proposed. In such devices, an organic semiconductor or nanoparticles are used as the photosensitive layers.

In a photoelectric converting film stack type solid-state imaging device, it is not necessary to dispose light receiving portions on the surface of a semiconductor substrate. Therefore, the number of pixels can be further increased in comparison to a CCD image sensor, so that a high-resolution image can be taken.

When the number of pixels is increased, however, the maximum number of electrons which can be obtained in each pixel is reduced. Even in a photoelectric converting film stack type solid-state imaging device, when a very dark scene is imaged, the output signal is excessively low in level, thereby causing a problem in that the noise level is relatively increased and an image of a low S/N ratio is obtained.

### SUMMARY OF THE INVENTION

It is an object of the invention to provide an imaging apparatus comprising a photoelectric converting film stack type solid-state imaging device which can take a high-resolution image in a bright scene, and which can take a high-sensitivity image in a dark scene.

The imaging apparatus of the invention is an imaging apparatus comprising a photoelectric converting film stack type solid-state imaging device which has: a semiconductor substrate in which signal charge accumulating regions disposed to respectively correspond to pixels, and vertical and horizontal transfer paths of a charge-coupled device type that read out and transfer signal charges accumulated in the signal charge accumulating regions are formed; and a photoelectric converting film stacked on the semiconductor substrate, signal charges which are photoelectrically converted by the photoelectric converting film, and which correspond to an amount of incident light being to be accumulated in the signal charge accumulating regions, wherein the apparatus further comprises means for adding together signal charges of plural pixels in a process in which the signal charges which are read out from the signal charge accumulating regions to the vertical transfer paths are transferred to the horizontal transfer path through the vertical transfer paths and transferred at the horizontal transfer path to be output to an outside.

According to the configuration, signal charges can be read out respectively from all the pixels so as to obtain high-resolution image data, and, in a dark scene, signal charges of plural pixels are added together, so that high-sensitivity image data can be obtained.

In the imaging apparatus of the invention, it is preferable that the adding means adds together signal charges of plural pixels in a vertical direction, in the vertical transfer paths.

According to the configuration, vertical pixel addition can be easily conducted without a memory for pixel addition.

In the imaging apparatus of the invention, it is preferable that the adding means controls a number of line shift pulses which are applied to the vertical transfer paths during a horizontal blanking period, thereby controlling a number of pixels which are to be subjected to the addition in a vertical direction.

According to the configuration, vertical pixel addition can be easily conducted without a memory for pixel addition.

In the imaging apparatus of the invention, it is preferable that the adding means controls a frequency of reset pulses which cause a reset gate to operate, thereby controlling a number of pixels which are to be subjected to addition in a horizontal direction, the reset gate being disposed in an output stage of the horizontal transfer path.

According to the configuration, horizontal pixel addition can be easily conducted without a memory for pixel addition.

In the imaging apparatus of the invention, it is preferable that pixels from which the signal charges are to be read out in reading to the vertical transfer paths are decimated.

According to the configuration, it is possible to obtain motion image data of a high frame rate.

In the imaging apparatus of the invention, it is preferable that a plurality of the photoelectric converting films are stacked on the semiconductor substrate, and the photoelectric converting films conduct photoelectric conversions on incident lights of different wavelengths, respectively.

According to the configuration, plural colors can be simultaneously detected by one pixel, and hence it is possible to solve the problems of a related art CCD image sensor, such as improvement of the resolution, improvement of the light use efficiency, suppression of a false color, and enhancement of the sensitivity.

In the imaging apparatus of the invention, it is preferable that the plural photoelectric converting films include: a first photoelectric converting film having a spectral sensitivity characteristic in which a peak is in a red region; a second photoelectric converting film having a spectral sensitivity characteristic in which a peak is in a green region; and a third photoelectric converting film having a spectral sensitivity characteristic in which a peak is in a blue region, and the addition of signal charges is conducted on signal charges of a same color.

According to the configuration, imaging of a color image based on the three primary colors is enabled, and an existing signal process circuit for R, G, and B signals can be used.

In the imaging apparatus of the invention, it is preferable that the plural photoelectric converting films further include a fourth photoelectric converting film having a spectral sensitivity characteristic in which a peak is in a medium color region between the blue and green regions.

According to the configuration, a signal obtained in the fourth photoelectric converting film can be subtracted from that obtained in the first photoelectric converting film, so that red corresponding to the human visibility can be obtained.

The imaging apparatus of the invention preferably further comprises means for selecting one of a high-sensitivity read mode in which the adding means adds together signal charges of plural pixels, and a high-resolution read mode in which addition is not conducted and signal charges of all pixels are read out without being changed.

According to the configuration, only when a dark scene is to be imaged, pixel addition is conducted to cause the solid-state imaging device to output high-sensitivity image data, and, when a bright scene is to be imaged, pixel addition is not conducted to cause the solid-state imaging device to output high-resolution image data.

According to the invention, it is possible to provide an imaging apparatus comprising a photoelectric converting film stack type solid-state imaging device which can take a high-resolution image in a bright scene, and which can take a high-sensitivity image in a dark scene.

### BRIEF DESCRIPTION OF THE DRAWINGS

FIG. 1 is a block diagram of a digital camera on which a solid-state color imaging device of the photoelectric converting film stack type of an embodiment of the invention is mounted.

FIG. 2 is a surface diagram of the photoelectric converting film stack type solid-state imaging device shown in FIG. 1.

FIG. 3 is an enlarged diagram of the inside of the rectangular frame III in FIG. 2.

FIG. 4 is a cross-sectional diagram taken along the line IV-IV in FIG. 3.

FIG. 5 is a surface diagram of the semiconductor substrate in a state which is obtained by removing away photoelectric converting films and the like stacked on the semiconductor substrate, from the state of FIG. 3.

FIG. 6 is a cross-sectional diagram taken along the line VI-VI in FIG. 3.

FIG. 7 is a cross-sectional diagram of an output stage of a horizontal transfer path shown in FIG. 2, taken along the transfer direction.

FIG. 8 is a view illustrating transferring operations through vertical transfer paths in the photoelectric converting film stack type solid-state imaging device shown in FIG. 1.

FIG. 9 is a timing chart of pixel addition in the horizontal direction in the horizontal transfer path shown in FIG. 7.

### DETAILED DESCRIPTION OF THE INVENTION

Hereinafter, an embodiment of the invention will be described with reference to the accompanying drawings.

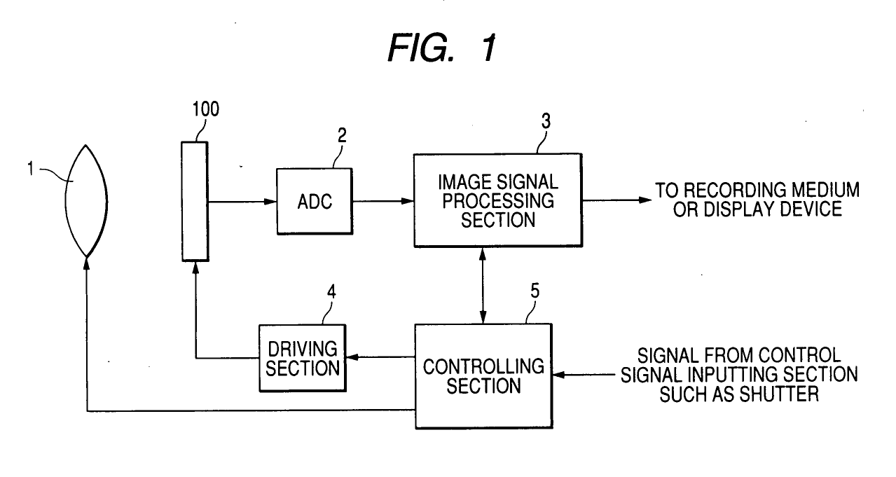

FIG. 1 is a block diagram of an imaging apparatus on which a solid-state imaging device of the photoelectric converting film stack type of an embodiment of the invention is mounted. The imaging apparatus comprises: an imaging optical system 1 including an imaging lens and an aperture; the photoelectric converting film stack type solid-state imaging device 100 which will be described later in detail; an analog/digital converter 2 which converts an analog image signal output from the photoelectric converting film stack type solid-state imaging device 100, to a digital signal; an image signal processing section 3 which applies image processing on the digital image signal, and which stores the processed signal onto a recording medium, or displays it on a display device; a driving section 4 which controls the operation of the photoelectric converting film stack type solid-state imaging device 100; and a controlling section 5 which receives signals from an operation section including a shutter button, and which controls the image signal processing section 3, the driving section 4, and the imaging optical system 1.

In the case where an analog/digital converting device is disposed integrally in an output stage of the photoelectric converting film stack type solid-state imaging device 100, the analog/digital converter 2 is not required.

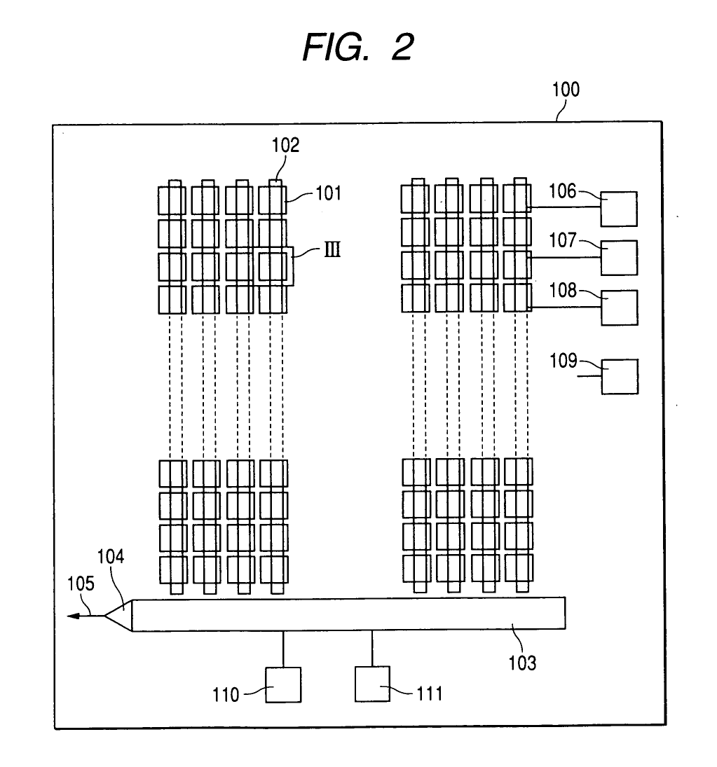

FIG. 2 is a surface diagram of the photoelectric converting film stack type solid-state imaging device 100 shown in FIG. 1. In the embodiment, in the photoelectric converting film stack type solid-state imaging device 100, many light receiving portions 101 are arranged in a square lattice manner. On the surface of a semiconductor substrate which is disposed below the light receiving portions 101 of the photoelectric converting film stack type solid-state imaging device 100, vertical transfer paths (column CCD registers) 102 are formed at positions overlapping with the light receiving portions 101 which are arranged in the column direction, respectively. A horizontal transfer path (row CCD register) 103 is formed in a lower side edge of the semiconductor substrate.

An output amplifier 104 is disposed in an exit portion of the horizontal transfer path 103. Signal charges detected in the light receiving portions 101 are first transferred to the horizontal transfer path 103 through the vertical transfer paths 102, and then transferred to the output amplifier 104 through the horizontal transfer path 103 to be output as an output signal 105 from the output amplifier 104.

On the surface of the semiconductor substrate, electrode terminals 106, 107, 108 connected to transfer electrodes which are superimposed on the vertical transfer paths 102, and which are not shown are disposed, an electrode terminal 109 which is to be connected to pixel electrodes of the light receiving portions 101 which will be described later is disposed, and electrode terminals 110, 111 for transfer through the horizontal transfer path 103 are disposed.

Vertical transfer pulse signals Φv1, Φv2, Φv3 which will be described later are applied to the electrode terminals 106, 107, 108, and horizontal transfer pulse signals ΦH1, ΦH2 which will be described later are applied to the electrode terminals 110, 111, respectively.

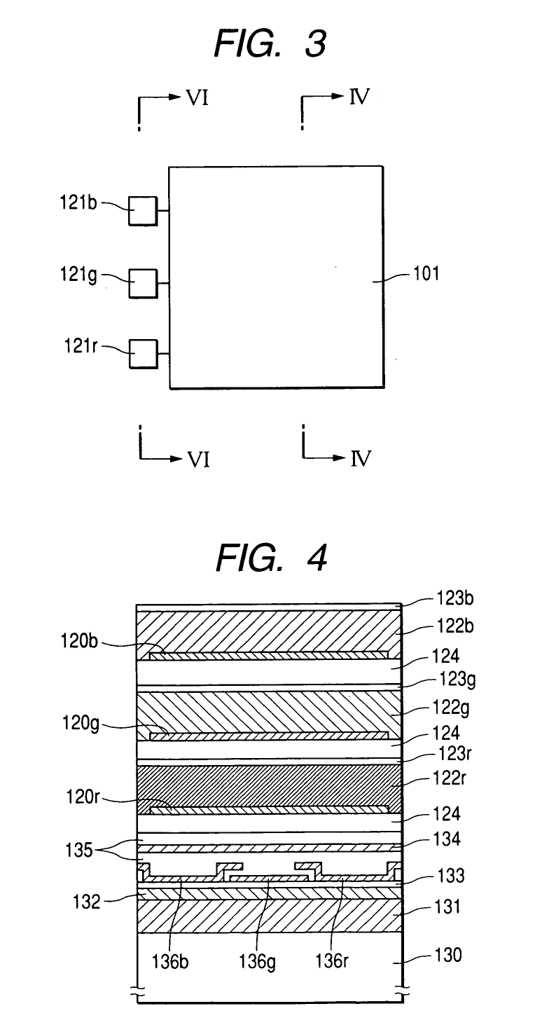

FIG. 3 is an enlarged diagram of the inside of the rectangular frame III in FIG. 2, and showing one light receiving portion 101 in an enlarged manner. In the embodiment, three connecting portions 121r, 121g, 121b are disposed for each light receiving portion, between each of the light receiving portions 101 arranged in the column direction, and the corresponding light receiving portion 101 in the adjacent column. The suffixes r, g, b correspond to red (R), green (G), and blue (B), respectively. This is applicable also to the subsequent description.

FIG. 4 is a cross-sectional diagram taken along the line IV-IV in FIG. 3. A P-well layer 131 is formed in an upper portion of an n-type semiconductor substrate 130, and an n-type semiconductor layer 132 constituting the vertical transfer paths 102 is disposed in a surface portion of the P-well layer 131. Transfer electrodes 136r, 136g, 136b made of polycrystalline silicon are formed on the surface of the n-type semiconductor layer 132 via a gate insulating film 133. An insulating film 135 is formed on the transfer electrodes via a light shielding film 134.

A transparent insulating film 124 is stacked on the insulating film 135, an electrode film (hereinafter, referred to as pixel electrode film) 120r which is partitioned for each light receiving portion 101 is stacked on the transparent insulating film, and a photoelectric converting film 122r for detecting red (R) is stacked on the electrode film. The photoelectric converting film 122r is not required to be disposed with being partitioned for respective light receiving portions, and is stacked as a single film over the whole light receiving surface where the light receiving portions 101 assemble.

A common electrode film 123r which is common to the light receiving portions 101 for detecting a red signal is similarly stacked as a single film on the photoelectric converting film 122r. Another transparent insulating film 124 is stacked on the common electrode film.

A pixel electrode film 120g which is partitioned for each light receiving portion 101 is stacked on the insulating film 124, a photoelectric converting film 122g for detecting green (G) is stacked as a single film on the electrode film in the same manner as described above, and a common electrode film 123g is stacked on the photoelectric converting film. A further transparent insulating film 124 is stacked on the common electrode film.

A pixel electrode film 120b which is partitioned for each light receiving portion 101 is stacked on the insulating film 124, a photoelectric converting film 122b for detecting blue (B) is stacked as a single film on the electrode film in the same manner as described above, and a common electrode film 123b is stacked on the photoelectric converting film.

The pixel electrode films 120b, 120g, 120r for each light receiving portion are disposed so as to be aligned in the direction of incident light. Namely, the photoelectric converting film stack type solid-state imaging device 100 of the embodiment is configured so that each of the light receiving portions 101 detects the three colors of red (R), green (G), and blue (B). Hereinafter, the term of “pixel” alone means the light receiving portion 101 which detects the three colors, and the term of a color pixel, a red pixel, a green pixel, or a blue pixel means a partial pixel (a portion of a photoelectric converting film sandwiched between the common electrode film and one pixel electrode film) which detects the corresponding color.

The connecting portion 121b shown in FIG. 3 is connected to the blue pixel electrode film 120b, the connecting portion 121g is connected to the green pixel electrode film 120g, and the connecting portion 121r is connected to the red pixel electrode film 120r. The electrode terminal 109 in FIG. 2 is commonly connected to the common electrode films 123b, 123g, 123r.

As the homogeneous and transparent electrode films 123r, 123g, 123b, 120r, 120g, 120b, thin films of tin oxide (SnO₂), titanium oxide (TiO₂), indium oxide (InO₂), or indium tin oxide (ITO) are used. However, the materials of the films are not restricted to these oxides.

The photoelectric converting films 122r, 122g, 122b may be formed by a single-layer film or a multilayer film. As the materials of the films, useful are various materials such as: silicon, a compound semiconductor, and a like inorganic material; an organic material including an organic semiconductor and organic pigment; and a quantum dot deposition film configured by nanoparticles.

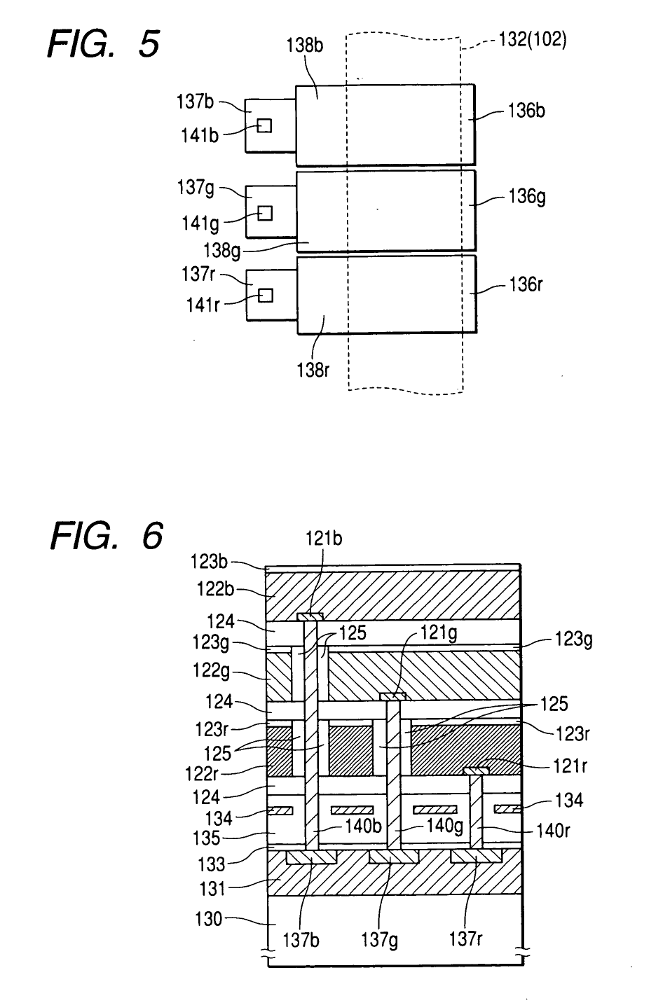

FIG. 5 is a surface diagram of the semiconductor substrate in a state which is obtained by removing away the portions above and including the light shielding film 134 in FIG. 4, from the state of FIG. 3. The three transfer electrodes 136r, 136g, 136b are disposed for the one pixel 101. An n-type heavily-doped impurity region 137r for accumulating signal charges generated in the red pixel of the pixel 101 is formed in the left of the transfer electrode 136r, an n-type heavily-doped impurity region 137g for accumulating signal charges generated in the green pixel is formed in the left of the transfer electrode 136g, and an n-type heavily-doped impurity region 137b for accumulating signal charges generated in the blue pixel is formed in the left of the transfer electrode 136b.

The transfer electrodes 136r, 136g, 136b are extended to the charge accumulating regions 137r, 137g, 137b so that extended portions 138r, 138g, 138b are formed as read gate portions for reading accumulated charges in the charge accumulating regions 137r, 137g, 137b into potential wells which are formed below the transfer electrodes 136r, 136g, 136b, respectively. Contact portions 141r, 141g, 141b to which vertical lines 140r, 140g, 140b that will be described later are to be connected are disposed in center areas of the charge accumulating regions 137r, 137g, 137b, respectively.

FIG. 6 is a cross-sectional diagram taken along the line VI-VI in FIG. 3. The layers are stacked on the semiconductor substrate in the same sequence as that shown in FIG. 4. The charge accumulating region 137r formed in the surface portion of the P-well layer 131, and the connecting portion 121r connected to the red electrode film 120r are connected to each other through the vertical line 140r. The charge accumulating region 137g formed in the surface portion of the P-well layer 131, and the connecting portion 121g connected to the green electrode film 120g are connected to each other through the vertical line 140g. The charge accumulating region 137b formed in the surface portion of the P-well layer 131, and the connecting portion 121b connected to the blue electrode film 120b are connected to each other through the vertical line 140b.

The vertical lines 140r, 140g, 140b have a structure which prevents electrical connections other than those with the connecting portions 121r, 121g, 121b and the charge accumulating regions 137r, 137g, 137b from occurring. Therefore, an insulating film 125 is applied to the peripheries of the vertical lines 140g, 140b which are to be connected to the pixel electrode films 120g, 120b in the upper layers.

The vertical lines 140g, 140b are preferably made of an optically transparent material, and also the insulating film 125 is preferably made of an optically transparent material.

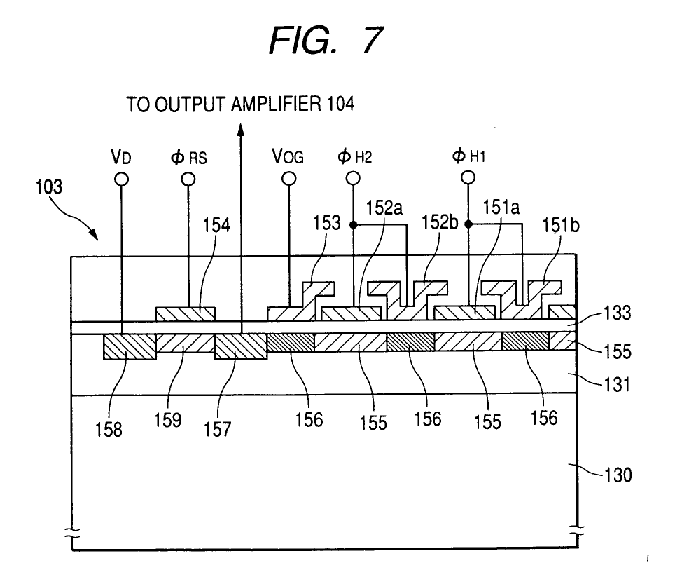

FIG. 7 is a cross-sectional diagram of the horizontal transfer path 103 shown in FIG. 2, taken along the transfer direction, and illustrating the vicinity of the output amplifier 104. In the P-well layer 131 formed in the surface portion of the n-type semiconductor substrate 130, n-type semiconductor regions 155, and other n-type semiconductor regions 156 which are lower in impurity concentration than the regions 155 are alternately disposed. Transfer electrodes 151a, 151b for a first phase to which the horizontal transfer pulse ΦH1 is to be applied are disposed on one set of regions 155, 156 via the gate insulating film 133, respectively, and transfer electrodes 152a, 152b for a second phase to which the horizontal transfer pulse ΦH2 is to be applied are disposed on the next set of regions 155, 156 via the gate insulating film 133, respectively.

An output gate 153 is disposed on the n-type semiconductor region 156 of the last stage, via the gate insulating film 133. An n-type heavily-doped impurity region (n⁺ region) 157 is disposed adjacent to the region 156. The n-type heavily-doped impurity region 157 is connected to the output amplifier 104.

An n-type semiconductor region 159 (which is approximately equal in impurity concentration to the regions 155) is disposed adjacent to the n-type heavily-doped impurity region 157, and an n-type heavily-doped impurity region 158 is disposed adjacent to the region 159. A reset gate 154 is disposed on the n-type semiconductor region 159 via the gate insulating film 133. A reset pulse ΦRS is applied to the reset gate 154.

When light is incident on the thus configured photoelectric converting film stack type solid-state imaging device 100, photo-charges corresponding to the amount of blue light are generated in the blue photoelectric converting film 122b, photo-charges corresponding to the amount of green light are generated in the green photoelectric converting film 122g, and photo-charges corresponding to the amount of red light are generated in the red photoelectric converting film 122r. When a voltage is applied between the common electrode films 123r, 123g, 123b, and the pixel electrode films 120r, 120g, 120b, these photo-charges or signal charges of respective colors flow into the charge accumulating regions 137r, 137g, 137b through the vertical lines 140r, 140g, 140b, to be accumulated therein.

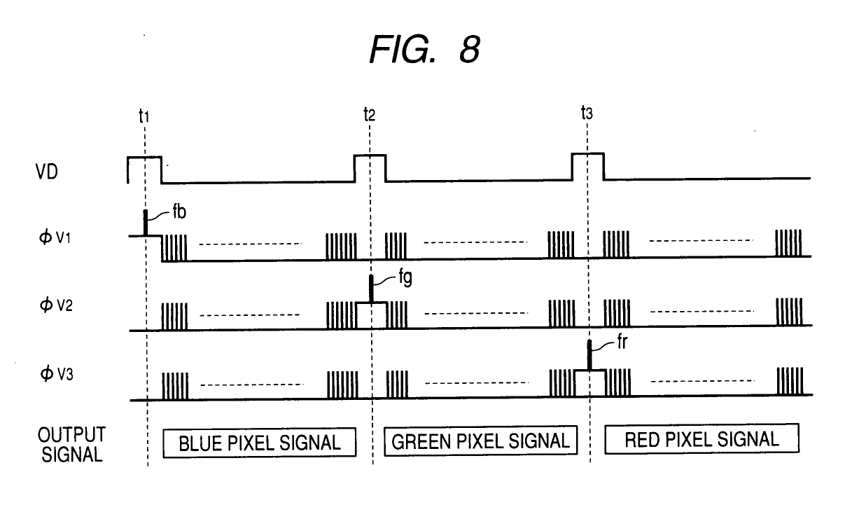

When the signal charges are to be read out from the solid-state imaging device 100, operations for reading are conducted in the same manner as in a related art CCD image sensor. As shown in FIG. 8, for example, a read pulse fb is first applied to the read gate 138b of FIG. 5. As a result, blue signal charges of all pixels are read into the potential wells due to the transfer electrodes 136b which are disposed below the respective pixels. Then, the first-phase vertical transfer pulse Φv1, the second-phase vertical transfer pulse Φv2, and the third-phase vertical transfer pulse Φv3 are applied to the transfer electrodes 136b, 136g, 136r, respectively, whereby the signal charges are transferred through the vertical transfer paths 102 to the horizontal transfer path 103.

In this case, when a line shift pulse is applied one time (360 deg.) during the horizontal blanking period to the vertical transfer paths 102, signal charges of blue pixels of the row which is closest to the horizontal transfer path 103 are first transferred into potential wells of the horizontal transfer path 103, and the signal charges of the one row are transferred toward the output amplifier 104 through the horizontal transfer path 103, so that signal charges of each color pixel are supplied from the n-type heavily-doped impurity region 157 of FIG. 7 to the output amplifier 104. Each time when signal charges of each color pixel are supplied to the output amplifier 104, the reset pulse ΦRS is applied to the reset gate 154 to discharge charges in the region 157.

The above operations are repeated times the number of which is equal to that of the pixel rows of the solid-state imaging device 100, so that blue signal charges of all pixels are output from the solid-state imaging device 100. When a read pulse fg is then applied to the read gate 138g of FIG. 5, green signal charges of all pixels are read into the vertical transfer paths 102, and similarly transferred through the vertical transfer paths 102 and the horizontal transfer path 103 to be output from the solid-state imaging device 100. When a read pulse fr is then applied to the read gate 138r of FIG. 5, red signal charges of all pixels are read into the vertical transfer paths 102, and similarly output from the solid-state imaging device 100.

The above operations constitute a high-resolution read mode in which color image data output from the solid-state imaging device 100 have a resolution corresponding to the number of pixels in the solid-state imaging device 100, so that high-resolution image data can be obtained.

When a dark scene is imaged by the photoelectric converting film stack type solid-state imaging device 100, the amounts of the respective signal charges are so small that an image of a low sensitivity is obtained. In such a case, therefore, the solid-state imaging device 100 is driven in a high-sensitivity read mode which will be described below.

In the high-sensitivity read mode, signal charges are read out while conducting pixel addition. In this mode, although the resolution is low, the amounts of signal charges to be read out are increased in accordance with the number of pixels in which signal charges are to be added together, and hence it is possible to obtain data of a bright image.

In the case where signal charges of two pixels arranged in the vertical direction are to be added together, the line shift pulse is applied two times (360 deg.×2) during the horizontal blanking period to the vertical transfer paths 102. Signal charges of the color pixels of the first row are transferred into the potential wells of the horizontal transfer path 103 by the application of the first line shift pulse. Then, signal charges of the color pixels of the second row are transferred into the same potential wells by the next line shift pulse.

In each of the potential wells of the horizontal transfer path 103, namely, signal charges of two pixels are accumulated. The signal charges are then horizontally transferred to be output. When the line shift pulse is applied three times during the horizontal blanking period to the vertical transfer paths 102, similarly, signal charges of three pixels arranged in the vertical direction are accumulated into the potential wells of the horizontal transfer path, and then output from the solid-state imaging device 100.

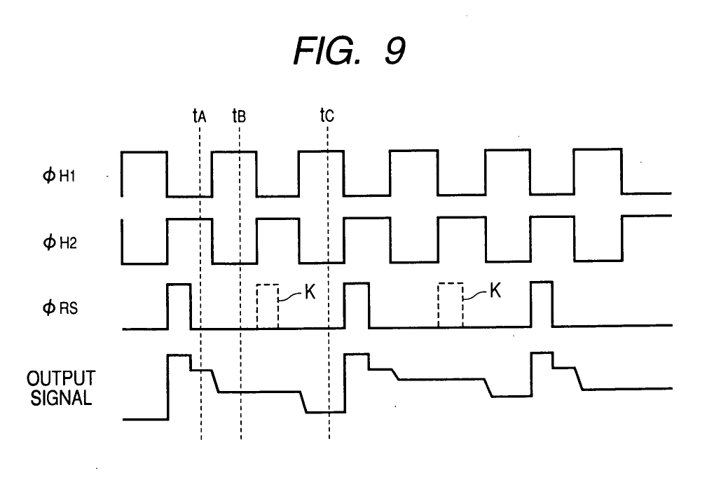

When signal charges are to be transferred through the horizontal transfer path 103 and output from the output amplifier 104, the reset pulse ΦRS is applied at, for example, timings shown in FIG. 9. In the high-resolution read mode, the reset pulse ΦRS is generated at the same period as the horizontal transfer pulses ΦH1, ΦH2. When the period of the reset pulse is doubled to eliminate the reset pulse at the positions indicated by the broken lines k as shown in FIG. 9, however, signal charges which are to be discarded into the region 158 by the reset pulse k remain in the region 157, and, in this state, signal charges which are transferred in the next potential well are added into the region 157.

In the case where signal charges of two pixels arranged in the vertical direction are moved in an added state through the horizontal transfer path 103 as described above, when the period of the reset pulse is doubled (the frequency is reduced to one half), signal charges of four color pixels in total are output in an added state from the solid-state imaging device 100. As a result, even when a dark scene is imaged, data of a bright image can be output from the solid-state imaging device 100, so that high-sensitivity image data can be obtained.

In the above-described example, signal charges of two color pixels are horizontally added together by doubling the period of the reset pulse. Of course, when the period of the reset pulse is increased three-fold, signal charges of three color pixels can be horizontally added together, and, when the period of the reset pulse is increased four-fold, signal charges of four color pixels can be horizontally added together. When the period of the reset pulse is controlled together with the number of line shift pulses which are generated during the horizontal blanking period, therefore, signal charges of an arbitrary number of color pixels can be output while being added together.

The color pixel addition in the embodiment described above is conducted with using the transfer paths. Therefore, a memory for the addition is not required, so that the production cost of the solid-state imaging device 100 can be reduced.

In the embodiment described above, signal charges of all color pixels are read out and added together. In the case where a motion image is requested and the device must operate at a high frame rate, the reading process may be conducted while decimating pixel rows in the vertical direction, and signal charges of nearby color pixels may be added together. Of course, the manner of connecting the transfer electrodes in the solid-state imaging device 100 must be changed.

In the embodiment described above, signal charges of the same color are read out by one read pulse. Alternatively, signal charges of different colors may be read out by one read pulse. In the alternative, signal charges of the same color must be continuously read out plural times in the horizontal or vertical direction. In this case, signal charges in the direction in the continuous readings can be added together in the same operations as those in the embodiment.

In the embodiment, the three photoelectric converting films are formed so as to have a three-layer structure, and incident light is detected while splitting the light into the three primary colors R, G, B. Alternatively, another configuration may be employed in which a fourth photoelectric converting film for detecting a medium color between green and blue is disposed in addition to the films for R, G, B, and incident light is detected while splitting the light into the four colors. According to the configuration, the color separation is conducted more finely, and the color reproducibility is improved.

In the embodiment, the three-phase driving is conducted on the vertical transfer paths 102. Alternatively, the vertical transfer paths may be driven with a phase number which is a multiple of 3. When the six-phase driving is conducted, for example, signal charges of all color pixels are read out by six reading operations. The amount of charges which can be transferred through the vertical transfer paths 102 is increased about four-fold, thereby producing an advantage that a large saturation output signal can be obtained. In the case where vertical two-color pixel addition is to be conducted, when a read pulse is applied simultaneously to the first and fourth phases, the second and fifth phases, or the third and sixth phases, color pixel addition is conducted in potential wells of the vertical transfer paths 102 at a timing of reading into the vertical transfer paths 102, and hence the line shift is requested to be conducted only one time during the horizontal blanking period. In the structure having four photoelectric converting films, although the four-phase driving is usually conducted, the eight-phase driving may be similarly conducted.

As described above, according to the embodiment, when a bright scene is to be imaged, signal charges of the pixels are read out as they are to obtain a high-resolution image, and, when a dark scene is to be imaged, signal charges of pixels of the same color are read out with being added together, to obtain a high-sensitivity image. When the addition is conducted on four pixels of two pixels in the vertical direction by two pixels in the horizontal direction, for example, the sensitivity is enhanced four-fold. Although the resolution is reduced to one half in both the vertical and horizontal directions, an image of a high S/N ratio is obtained.

Depending on the brightness of the scene to be imaged, a digital camera may automatically select whether image data are read out from the solid-state imaging device in the high-resolution read mode or in the high-sensitivity read mode. Alternatively, the selection may be conducted in accordance with selection instructions from the user.

In the photoelectric converting film stack type solid-state imaging device in the invention, even when the number of pixels is increased, it is possible to output high-sensitivity image data. Therefore, the device is useful when mounted on a digital camera.

1. An imaging apparatus provided with a photoelectric converting film stack type solid-state imaging device comprising:
a semiconductor substrate;
a photoelectric converting film that photoelectrically converts an incident light and is stacked on the semiconductor substrate;
signal charge accumulating regions each of which accumulates signal charges according to an amount of the incident light photoelectrically converted by the photoelectric converting film and corresponds to a pixel;
vertical and horizontal transfer paths of a charge-coupled device type that read out and transfer the signal charges accumulated in the signal charge accumulating regions; and
an adding unit that adds the signal charges of a plurality of the pixels in a process in which the signal charges which are read out from the signal charge accumulating regions to the vertical transfer paths are transferred to the horizontal transfer path through the vertical transfer paths and transferred at the horizontal transfer path to be output to an outside.

2. The imaging apparatus according to claim 1, wherein the adding unit adds the signal charges of the plurality of the pixels in a vertical direction, in the vertical transfer paths.

3. The imaging apparatus according to claim 1, wherein the adding unit controls a number of line shift pulses which are applied to the vertical transfer paths during a horizontal blanking period so as to control a number of pixels which are to be added in a vertical direction.

4. The imaging apparatus according to claim 1, wherein the adding unit controls a frequency of reset pulses which cause a reset gate to operate so as to control a number of pixels which are to be added in a horizontal direction, the reset gate being disposed in an output stage of the horizontal transfer path.

5. The imaging apparatus according to claim 1, wherein pixels from which the signal charges are to be read out in reading out to the vertical transfer paths are decimated.

6. The imaging apparatus according to claim 1, wherein the photoelectric converting film comprises a plurality of photoelectric converting films stacked on the semiconductor substrate, and the photoelectric converting films conduct photoelectric conversions on incident lights of different wavelengths, respectively.

7. The imaging apparatus according to claim 6, wherein the plurality of photoelectric converting films comprising: a first photoelectric converting film having a spectral sensitivity characteristic in which a peak is in a red region; a second photoelectric converting film having a spectral sensitivity characteristic in which a peak is in a green region; and a third photoelectric converting film having a spectral sensitivity characteristic in which a peak is in a blue region, and the signal charges which are to be added are signal charges of a same color.

8. The imaging apparatus according to claim 7, wherein the plurality of the photoelectric converting films further comprises a fourth photoelectric converting film having a spectral sensitivity characteristic in which a peak is in a medium color region between the blue and green regions.

9. The imaging apparatus according to claim 1, wherein the apparatus further comprises a selecting unit that selects one of a high-sensitivity read mode in which the adding unit adds the signal charges of the plurality of pixels, and a high-resolution read mode in which an addition is not conducted and the signal charges of all pixels are read out without being changed.

10. An imaging apparatus provided with a photoelectric converting film stack type solid-state imaging device comprising:
a semiconductor substrate;
a photoelectric converting film that photoelectrically converts an incident light and is stacked on the semiconductor substrate;
signal charge accumulating regions each of which accumulates signal charges according to an amount of the incident light photoelectrically converted by the photoelectric converting film and corresponds to a pixel;
vertical and horizontal transfer paths of a charge-coupled device type that read out and transfer the signal charges accumulated in the signal charge accumulating regions; and
means for adding the signal charges of a plurality of the pixels in a process in which the signal charges which are read out from the signal charge accumulating regions to the vertical transfer paths are transferred to the horizontal transfer path through the vertical transfer paths and transferred at the horizontal transfer path to be output to an outside.

11. The imaging apparatus according to claim 10, wherein the adding means adds the signal charges of the plurality of the pixels in a vertical direction, in the vertical transfer paths.

12. The imaging apparatus according to claim 10, wherein the adding means controls a number of line shift pulses which are applied to the vertical transfer paths during a horizontal blanking period so as to control a number of pixels which are to be added in a vertical direction.

13. The imaging apparatus according to claim 10, wherein the adding unit controls a frequency of reset pulses which cause a reset gate to operate so as to control a number of pixels which are to be added in a horizontal direction, the reset gate being disposed in an output stage of the horizontal transfer path.

14. The imaging apparatus according to claim 10, wherein pixels from which the signal charges are to be read out in reading out to the vertical transfer paths are decimated.

15. The imaging apparatus according to claim 10, wherein the photoelectric converting film comprises a plurality of photoelectric converting films stacked on the semiconductor substrate, and the photoelectric converting films conduct photoelectric conversions on incident lights of different wavelengths, respectively.

16. The imaging apparatus according to claim 15, wherein the plurality of photoelectric converting films comprising: a first photoelectric converting film having a spectral sensitivity characteristic in which a peak is in a red region; a second photoelectric converting film having a spectral sensitivity characteristic in which a peak is in a green region; and a third photoelectric converting film having a spectral sensitivity characteristic in which a peak is in a blue region, and the signal charges which are to be added are signal charges of a same color.

17. The imaging apparatus according to claim 16, wherein the plurality of the photoelectric converting films further comprises a fourth photoelectric converting film having a spectral sensitivity characteristic in which a peak is in a medium color region between the blue and green regions.

18. The imaging apparatus according to claim 10, wherein the apparatus further comprises means for selecting one of a high-sensitivity read mode in which the adding unit adds the signal charges of the plurality of pixels, and a high-resolution read mode in which an addition is not conducted and the signal charges of all pixels are read out without being changed.
